(19) United States
(12) Patent Application Publication
(10) Pub. No.: US 2018/0365110 A1
(43) Pub. Date: Dec. 20, 2018

(54) APPLICATION-AWARE DATABASE BACKUPS

(71) Applicant: HEWLETT PACKARD ENTERPRISE DEVELOPMENT LP, Houston, TX (US)

(72) Inventors: Lokesh Murthy VENKATESH, Bangalore (IN); Nandan SHANTHARAJ, Bangalore (IN); Sunil TURAKANI, Bangalore (IN)

(21) Appl. No.: 16/060,022

(22) PCT Filed: Mar. 10, 2016
(86) PCT No.: PCT/US2016/021805

§ 371 Date: Jun. 6, 2018

(30) Foreign Application Priority Data
Dec. 7, 2015 (IN) 6536/CHE/2015

(51) Int. Cl. G06F 11/14; G06F 9/455; G06F 9/54; G06F 17/30

(52) U.S. Cl. CPC G06F 11/1458; G06F 9/45558; G06F 9/54; G06F 2009/45579; G06F 2009/45583; G06F 2201/84; G06F 17/30088

(57) ABSTRACT

A computing system may comprise a virtual machine and a computing device external to the virtual machine. The virtual machine may execute a database, receive a database backup request from the computing device, and responsive to receiving the database backup request, perform an application-aware backup of the database using a database backup utility to create a database backup image. The virtual machine may further store the snapshot image on storage accessible to the computing device.

### BACKGROUND

Enterprises are increasingly moving towards virtualizing servers to reduce power consumption, reduce hardware cost, and to increase resource utilization. One example of a type of server that may be virtualized is a database server.

### BRIEF DESCRIPTION OF THE DRAWINGS

Certain examples are described in the following detailed description and in reference to the drawings, in which:

FIG. 1 is a conceptual diagram of an example computing system for performing application-aware database backups;

FIG. 2 is another conceptual diagram of an example computing system for performing application-aware database backups;

FIG. 3 is another conceptual diagram of an example computing system for performing application-aware database backups;

FIG. 4 is a flowchart of an example method for performing application-aware database backups;

FIG. 5 is a flowchart of an example method for performing application-aware database backups;

FIG. 6 is a block diagram of an example for performing application-aware database backups;

FIG. 7 is a block diagram of an example for performing application-aware database backups.

### DETAILED DESCRIPTION OF SPECIFIC EXAMPLES

Computing systems may comprise virtualized computing devices, referred to as virtual machines. A single physical server may execute multiple virtual machines. The server that executes the virtual machines may be referred to as a “host,” and the virtual machines may be referred to as “guests.” As examples, a host may comprise virtual machines for each of a mail server, web server, and database server, respectively. By consolidating multiple virtual machines onto a single a physical computing device, virtualization may reduce power consumption, and increase server resource utilization, which may reduce total cost of ownership. Additionally, virtual machines may be easier and quicker for system administrators to deploy relative to deploying physical servers.

One example of an application that a virtual machine may execute is a database application. A database is an application that stores large amounts of data for quick retrieval. Some databases may store certain critical data that should be preserved in the event of system failure. To preserve such critical data, a computing device executing the database application, or another computing device may backup the contents of the database to avoid data loss in the event of a system crash, power failure or system failure. On a non-virtualized database server, there may be sufficient resources available to the physical database server to allow a backup agent application executing on the database server to perform backup of the database.

However, in the case of a virtual machine executing a database, the virtual machine may lack sufficient resources to perform backup of the database. For example, the virtual machine may be unable to perform a backup using a backup agent that executes on the virtual machine due to high resource consumption of the backup agent, and the lack of resources available to the virtual machine. The backup agent may be neither installed on the virtual machine nor temporarily pushed to the virtual machine at runtime.

A backup utility performs backup of a database. In some examples, the database application may be aware that the backup utility is performing a backup, which is referred to as an “application-aware” backup, due to backup metadata being stored by the database. An application-aware backup utility may be useful because the database may know where backup images created by the backup application are stored. The database application may refer to the backups for later use, e.g. to restore a backup. Techniques of this disclosure are related to performing application-aware backup of a database executing on a virtual machine while reducing resource consumption of the virtual machine during the backup operation.

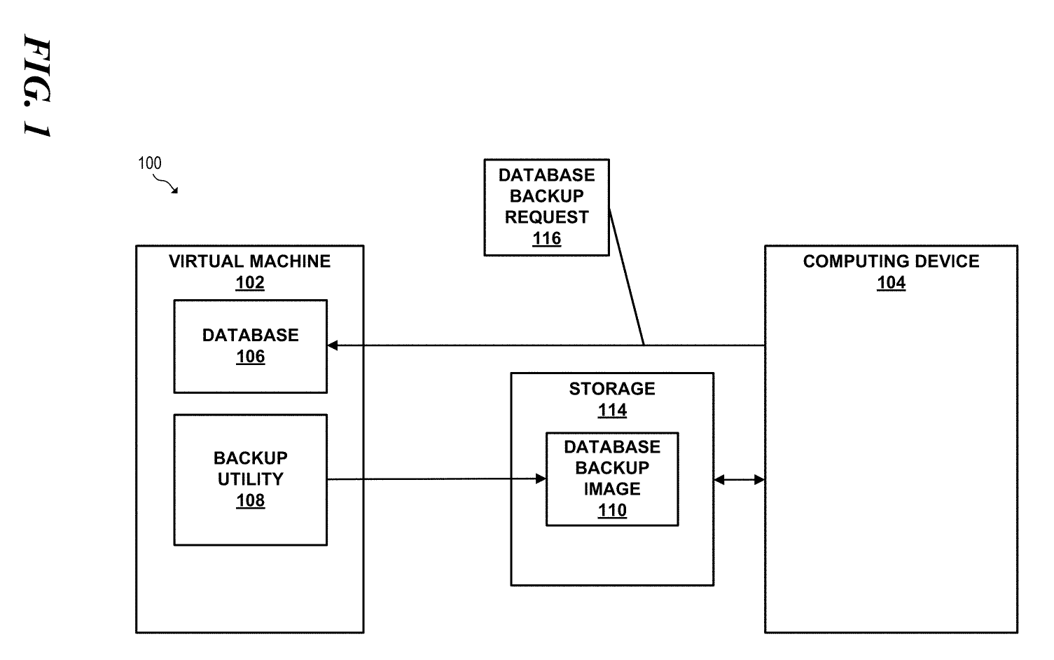

FIG. 1 is a conceptual diagram of an example computing system for performing application-aware database backups. Computing system 100 is illustrated in FIG. 1. Computing system 100 further comprises virtual machine 102, and computing device 104. In various examples, virtual machine 102 and computing device 104 may be managed by a single virtual host in some examples. In some examples, a host may manage virtual machine 102, and computing device 102 may comprise a physically separate computing device, such as another server.

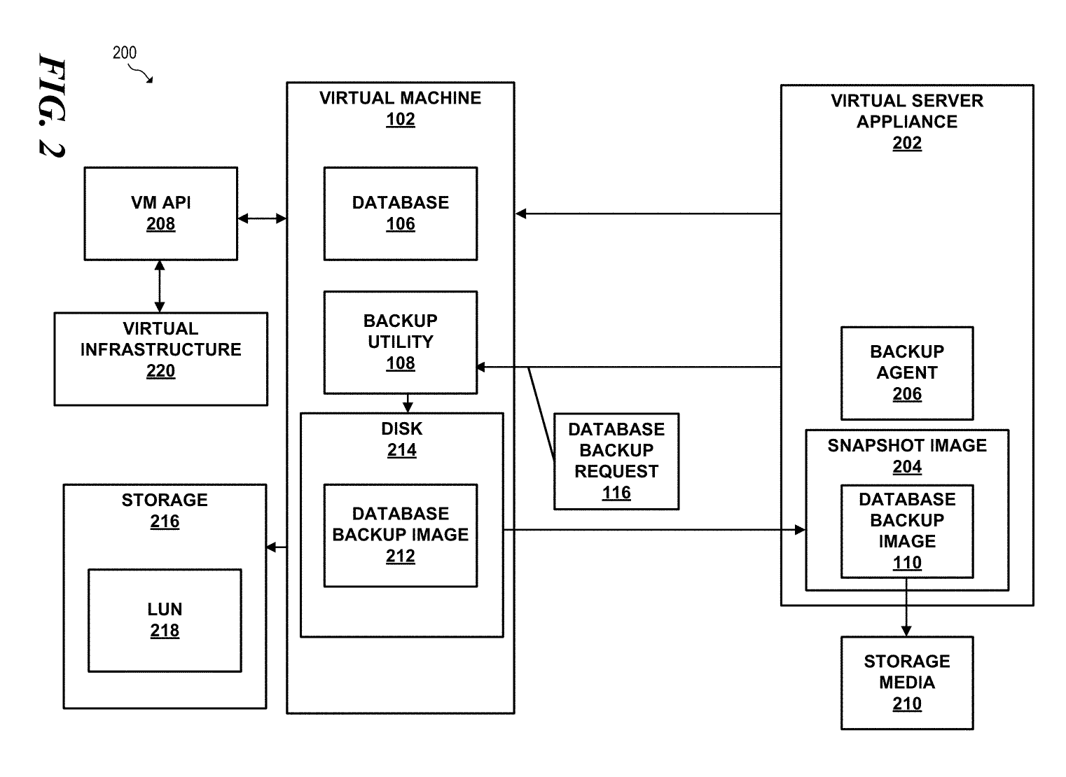

Computing device 104 and virtual machine 102 may be communicatively coupled via a network, such as a local area network (LAN), storage area network (SAN), virtual network, or the like in various examples. Computing device 104 may comprise a virtual server appliance in some examples, which is illustrated in greater detail in FIG. 2.

Computing device 104 may be coupled with storage 114. In some examples, the host server that encompasses virtual machine 102 may be coupled with storage 114. Storage 114 may be either internal or external to computing device 104 in various examples. Storage 114 may comprise one or a plurality of storage devices. In various examples, storage 114 may comprise a network share, such as a network file system (NFS) share. Additionally, it should be understood that storage 114 may comprise a plurality of storage devices, such as a storage area network (SAN), network attached storage (NAS), a storage array, a tape backup device, or any combination thereof or the like.

Virtual machine 102 executes database 106, and backup utility 108. As some examples, database application 106 may comprise: Oracle, Vertica, DB2, Informix, Microsoft SQL Server, or the like. Backup utility 108 also executes on virtual machine 102. Backup utility 108 creates a database backup image 110. Backup image 110 may comprise a full, incremental, or differential backup of database 106 in various examples. As illustrated in greater detail below, in some examples, backup utility 108 may initially store a database backup image on a virtual disk of virtual machine 102. In various examples, backup utility 108 may store database backup image 110 on storage 114, which is external to virtual machine 102.

Backup utility 108 may create a backup of database 106 based on knowledge of the structure and/or inner workings of database 106. Database 106 may be aware of when backup utility 108 executes as the backup utility records the backup metadata, i.e. the backup may be application-aware. Oracle Recovery Manager (RMAN) is an example of backup utility 108 for an Oracle database. Backup utility 108 may comprise a different backup utility for a different database 106.

In accordance with the techniques of this disclosure, virtual machine 102 may execute database 106 in virtual machine 102. Computing device 104 may initiate database backup request 116 for virtual machine 102 to backup database 106. Virtual machine 102 may receive a database backup request 116 from computing device 104, which is external to virtual machine 102. Responsive to receiving database backup request 116, virtual machine 102 may perform an application-aware backup of database 106 using database backup utility to create database backup image 110. Virtual machine 102 may store database backup image on storage 114.

In a generally reciprocal manner, computing device 104 may restore database backup image from storage 114. That is, computing device 104 may restore database backup image 110 to a local disk of virtual machine 102. Computing device 104 may specify the path to database backup image 110 to backup utility 108, e.g. as an argument, and backup utility 108 may restore backup image 110 to database 106.

FIG. 2 is another conceptual diagram of an example computing system for performing application-aware database backups. FIG. 2 illustrates a computing system 200. In various examples, computing system 200 may be similar to computing system 100 (FIG. 1). Computing system 200 comprises virtual machine 102 as well as virtual server appliance 202. Virtual server appliance 202 and virtual machine 102 may both be guest virtual machines executing under a host server in some examples. In other examples, virtual server 202 may execute on a separate computing device relative to the host machine that provides resources of virtual machine 102. Computing system 200 further comprises storage 216, Storage 216 may be coupled with virtual machine 102.

Virtual server appliance 202 may comprise software that executes on a computing device, such as a host server. In some examples, virtual server appliance 202 may be an example of computing device 104. Virtual server appliance 202 may be coupled with storage media 210 in various examples. Storage media 210 may comprise a backup storage media, such as a tape backup, storage array, or the like.

Computing system 200 also comprises virtual infrastructure 220 may comprise a virtual management server, such as a vCenter server appliance (vCSA) or the like. Virtual infrastructure 220 may execute on a computing device separate from virtual machine 102 or on the same computing device that executes virtual machine 102, such as a host server. Virtual infrastructure 208 support VM application programming interface (API) 208. VM API 208 may further comprise VM agents and/or tools provided by a virtualization vendor, such as VMWare tools. In various examples, VM API 208 may comprise drivers and/or tools that are installed on a virtual machine, such as virtual machine 102. Virtual server appliance 202 may interact with VM API 208 via virtual infrastructure 220 to call various functions and/or perform certain actions on virtual machine 102.

In the example of FIG. 2, virtual server appliance may call a function of VM API 208 to determine a list of processes executing on virtual machine 102 by sending a request to virtual infrastructure 220. In examples where virtual machine 102 comprises a VMWare virtual machine or the like, virtual server appliance 202 may query the processes executing on virtual machine 102 using the VMware Guest API ListProcessesInGuest( . . . ) function or a similar function that allows for auto-discovery (i.e. determination) of the database or application executing in the VM.

Based on the list of executing processes returned from VM API 208, virtual service appliance 202 may determine the specific database 106 that virtual machine 108 is executing. For example, based on the returned list of processes, virtual service appliance 202 may determine that virtual machine 102 is executing an Oracle database, or alternatively a Microsoft SQL Server database.

Responsive to determining the process associated with database 106, virtual server appliance 202 may issue database backup request 116. Database backup request 116 may further comprise a call to VM API 208 that is supported with virtual infrastructure 220 that causes virtual machine 102 to execute backup utility 108. More particularly, virtual server appliance may execute a StartProgramInGuest( . . . ) function using VM API 208 to cause virtual machine 102 to execute the backup utility 108 associated with database 106. As an example, virtual server appliance 202 may use the StartProgramInGuest( . . . ) function to cause virtual machine 102 to execute the Oracle RMAN utility, which is associated with database 106, e.g. in the case that database 106 comprises an Oracle database.

Upon execution, backup utility 108 may create a backup of database 106, e.g. database backup image 212. In some examples illustrated in FIG. 2, backup utility 108 may create database backup image 212 on a local disk 214 of virtual machine 102.

In some examples, responsive to backup utility 108 having finished creating database backup image 212, backup agent 206 of virtual server appliance 202 may use, i.e. request that virtual infrastructure 220 create a snapshot image 204 of virtual machine 102. Responsive to receiving the snapshot request, Virtual infrastructure 220 may create a snapshot image 204 of disk 214, again using VM API 208.

During the creation of snapshot image 204, Virtual infrastructure 220 creates two images: a read-only base disk image, and a delta disk image. The delta disk image includes any changes to virtual machine 102, such as file system operations, and database transactions that occur after the initial snapshot request is made.

Responsive to creating the read-only base disk image, Virtual infrastructure 220 may hot-add the base disk image to virtual server appliance 202. Responsive to backup agent 206 completing the backup of database image 110 to storage media 210, Virtual infrastructure 220 may consolidate the delta image with the read-only base disk image.

By creating a snapshot image, the contents of the disk 214 are captured in a crash-consistent manner. In addition to capturing a database backup image 212, creating a snapshot image captures the rest of the state of virtual machine 102, and the state may be reverted to, which may avoid loss of long-running work, that virtual machine 102 is performing.

Responsive to completing the database backup image 112 and/or hot-adding snapshot image 204 of virtual machine 102, backup agent 206 may backup snapshot image 204 or database backup image to storage media 210 that is external to virtual server appliance 202 in some examples. In various examples, storage media 210 may comprise tape backup, solid state backup, hard disk backup, or other non-volatile backup accessible to virtual server appliance 202.

Backup agent 206 may be aware of the location database backup 112 is located within snapshot image 204 because the path indicating the location of database backup image 110 may have been previously specified in database backup request 116. By having snapshot image 204 mounted on virtual storage appliance 202, the speed of backing up database backup 112 to storage media 210 may be reduced relative to backing up database 106 to storage media 210 over a network.

In various examples, the computing device (e.g., a host server) executing virtual machine 102 may be coupled with storage 216. Storage 216 may comprise a storage array, such as an HP 3PAR storage array, or the like, in various examples. Responsive to creating snapshot image 204, virtual server appliance 202 may replicate virtual machine 102 and its snapshot image 204 to a LUN 218 of storage 216 using, array replication technology, such as HPE Data Protector Zero Downtime Backup (ZDB), as an example.

A logical unit number (LUN) may comprise a logical unit of storage 216, e.g. of a storage array, that may store virtual machines. LUN 218 may be addressable using a storage protocol, such as SCSI, iSCSI, or Fibre Channel. Responsive to replicating virtual machine 102 and snapshot image 204 to storage 216, virtual infrastructure 220 may present the replicated LUN to VSA 202. VSA 202 may mount the replica LUN. VSA 202 may backup the replica LUN to storage media 210 in various examples.

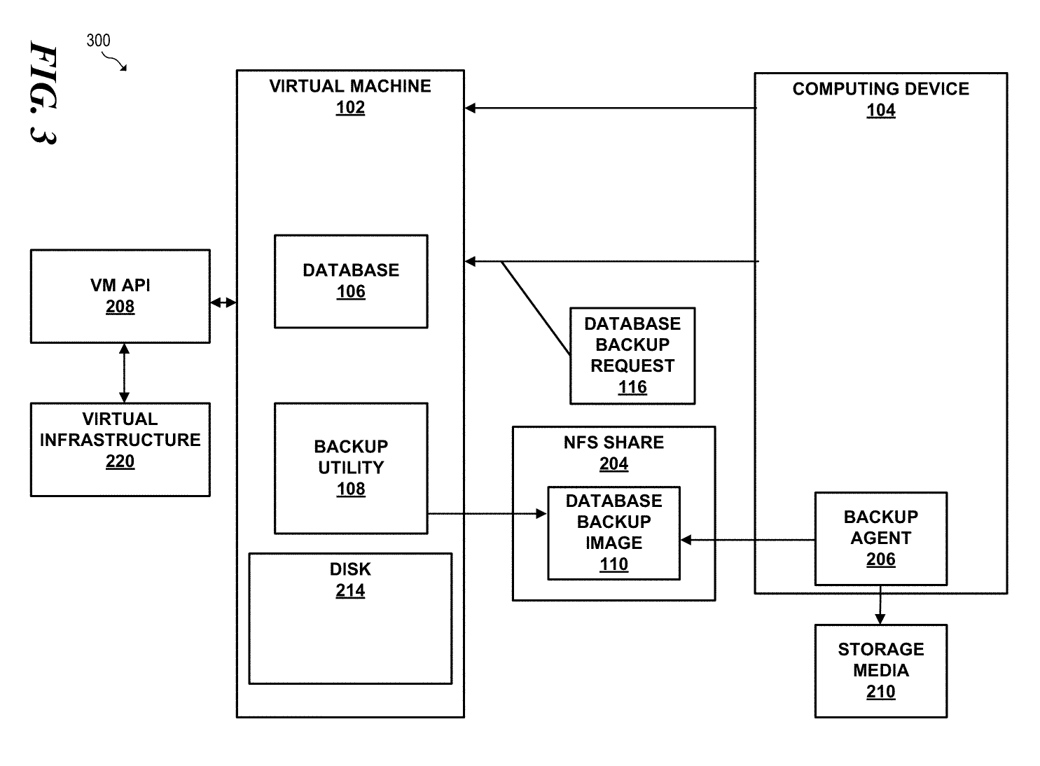

FIG. 3 is another conceptual diagram of an example computing system for performing application-aware database backups. FIG. 3 illustrates a computing system 300. In various examples, computing system 300 may be similar to computing system 100 (FIG. 1) and/or computing system 200 (FIG. 2).

Computing system 300 comprises virtual machine 102 as well as computing device 104. Virtual server appliance 202 may comprise a virtual machine residing on a host computing device, such as a host server. In some examples. Computing device may be part of the host server or may be a separate computing device that is external to the host server.

Computing system 300 is illustrated in additional detail relative to computing system of FIG. 1. Computing system 300 comprises a virtual infrastructure 220, which supports VM application programming interface (API) 208. Virtual server appliance 202 may interact with VM API 208 and virtual infrastructure 220 to determine a process associated with database 106, e.g. using an API call, as described elsewhere. In various examples, VM API 208 may be accessible via virtual infrastructure 220.

Responsive to determining the process associated with database 106 using VM API 208, virtual server appliance issues database backup request 116. Database backup request 116 may cause database 106 to generate database backup image 110. Virtual machine 102 may store database backup image 110 on NFS share 204 directly. NFS share 204 may be communicatively coupled to virtual server appliance 202 and/or virtual machine 102 in some examples.

In the example that database backup image 110 is stored to NFS share 204, the snapshot of virtual machine 102 may not be performed. Responsive to database backup image 110 being stored to NFS share 204, backup agent 206 may backup database backup image 110 to storage media 210.

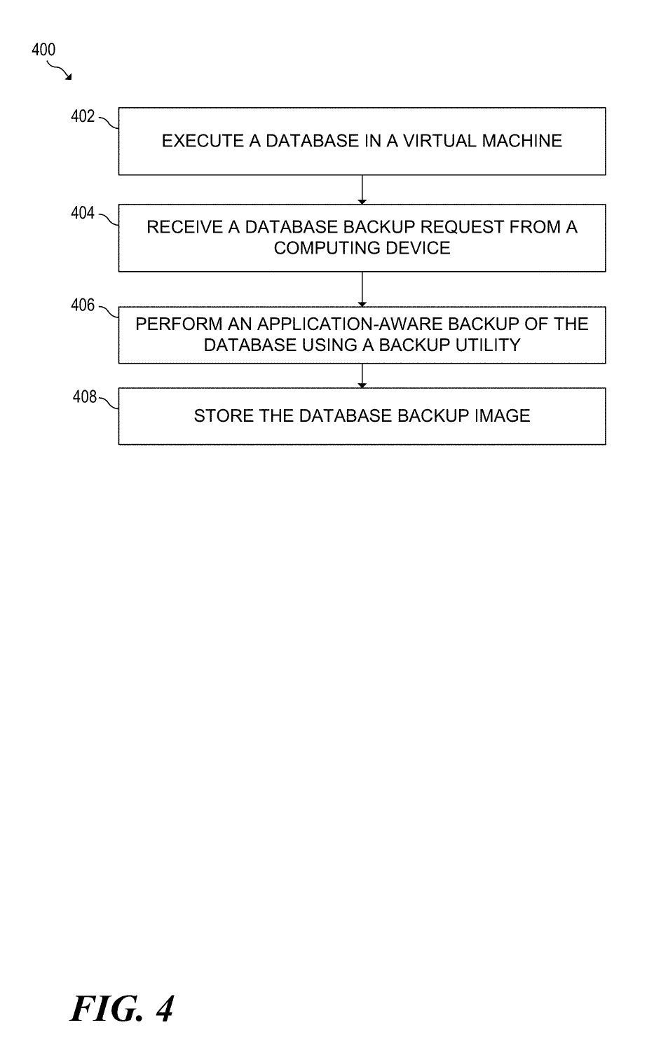

FIG. 4 is a flowchart of an example method for performing the application-aware database backups in accordance with the techniques of this disclosure. Method 400 may be described below as being executed or performed by a system, for example, computing system 100 (FIG. 1), computing system 200 (FIG. 2) or computing system 300 (FIG. 3). Other suitable systems and/or computing devices may be used as well. Method 400 may be implemented in the form of executable instructions stored on at least one machine-readable storage medium of the system and executed by at least one processor of the system. Alternatively or in addition, method 400 may be implemented in the form of electronic circuitry (e.g., hardware). In alternate examples of the present disclosure, one or more blocks of method 400 may be executed substantially concurrently or in a different order than shown in FIG. 4. In alternate examples of the present disclosure, method 400 may include more or fewer blocks than are shown in FIG. 4. In some examples, one or more of the blocks of method 400 may, at certain times, be ongoing and/or may repeat.

Method 400 may start at block 402 at which point the computing system may execute a database in a virtual machine, e.g. virtual machine 102. The computing system may further receive a database backup request, e.g., database backup request 116, from a computing device external to the virtual machine (102), such as computing device 104. Virtual machine 102 may perform an application-aware backup of the database, e.g. database 106, using a backup utility, such as backup utility 108, executing on virtual machine 102 to create a database backup image, e.g. database backup image 110 (406). A backup utility, such as backup utility 108 may store database backup image 110 on storage external to the virtual machine (408), e.g. storage 114.

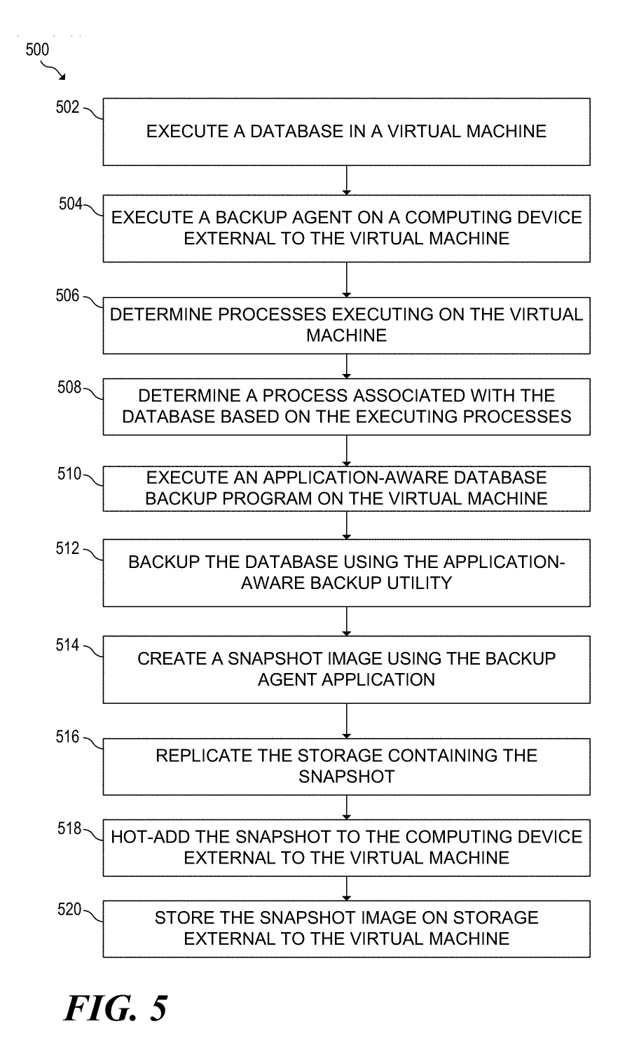

FIG. 5 is a flowchart of an example method for performing the application-aware database backups in accordance with the techniques of this disclosure. Method 500 may be described below as being executed or performed by a system, for example, computing system 100 (FIG. 1), computing system 200 (FIG. 2) or computing system 300 (FIG. 3). Other suitable systems and/or computing devices may be used as well. Method 500 may be implemented in the form of executable instructions stored on at least one machine-readable storage medium of the system and executed by at least one processor of the system. Alternatively or in addition, method 500 may be implemented in the form of electronic circuitry (e.g., hardware). In alternate examples of the present disclosure, one or more blocks of method 500 may be executed substantially concurrently or in a different order than shown in FIG. 5. In alternate examples of the present disclosure, method 500 may include more or fewer blocks than are shown in FIG. 5. In some examples, one or more of the blocks of method 500 may, at certain times, be ongoing and/or may repeat.

Method 500 may start at block 502 at which point the computing system may execute a database 106 in a virtual machine, e.g. virtual machine 102. In various examples, the computing system, and in particular virtual server appliance 202, may further execute a backup agent on the computing device external to the virtual machine (504), determine processes executing on virtual machine 102 using an application programming interface (API) of the virtual machine (506), such as VM API 208. The computing system, and virtual server appliance 202 as an example, may further determine a process associated with database 106 based on the executing processes (508), and execute a database backup utility 108 on virtual machine 102 using VM API 208 of virtual infrastructure 220, and based on the determined process associated with database 106 (510).

Method 500 may proceed to block 512 where in some examples, the computing system, and virtual machine 102 as an example, may then perform an application-aware backup of database 106 using backup utility 108 executing on virtual machine 102. In some examples, database backup image 212 may be stored is stored on a local disk 214 of virtual machine 102. In some examples, the storage external to virtual machine 102 may comprise an NFS share 204, of VSA 202 (FIG. 3).

Method 500 may further proceed to block 514, where Virtual infrastructure 220 may create at least one of a snapshot image 204 of virtual machine 102 or a read-only disk of virtual machine 102 (514), hot-add the at least one of snapshot image 204 or the read-only disk to the computing device external to virtual machine 202, e.g. virtual server appliance 202 (516). Virtual server appliance 202 may store database backup image 110 or files of snapshot image to storage external to virtual machine 102, e.g. storage media 210 (518).

In the preceding description, numerous details are described to provide an understanding of the subject disclosed herein. However, implementations may be practiced without some or all of these details. Other implementations may include modifications and variations from the details discussed above. It is intended that the appended claims cover such modifications and variations.

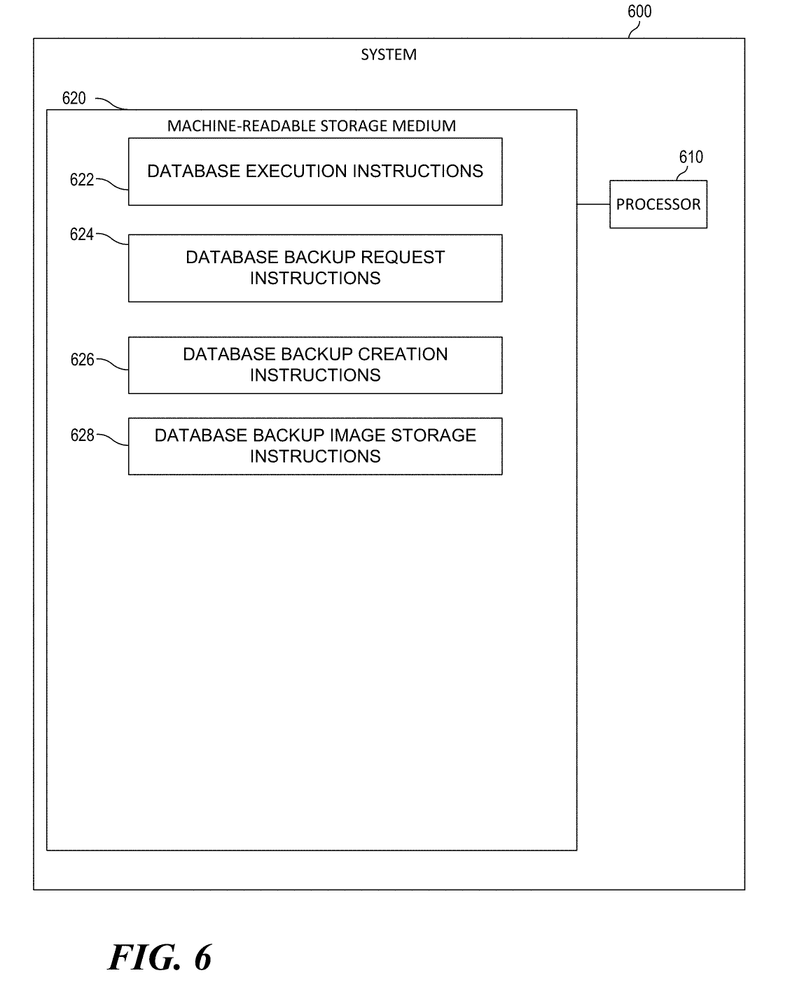

FIG. 6 is a block diagram of an example system for managing firmware of a computing system. In the example of FIG. 6, system 600 includes a processor 610 and a machine-readable storage medium 620. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 610 may be one or more central processing units (CPUs), microprocessors, and/or other hardware devices suitable for retrieval and execution of instructions stored in machine-readable storage medium 620. In the particular example shown in FIG. 6, processor 610 may fetch, decode, and execute instructions 622, 624, 626, 628 to manage firmware of computing system 600. As an alternative or in addition to retrieving and executing instructions, processor 610 may include one or more electronic circuits comprising a number of electronic components for performing the functionality of one or more of the instructions in machine-readable storage medium 620. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Machine-readable storage medium 620 may be any electronic, magnetic, optical, or other physical storage device that stores executable instructions. Thus, machine-readable storage medium 620 may be, for example, Random Access Memory (RAM), an Electrically-Erasable Programmable Read-Only Memory (EEPROM), a storage drive, an optical disc, and the like. Machine-readable storage medium 620 may be disposed within system 600, as shown in FIG. 6. In this situation, the executable instructions may be “installed” on the system 600. Alternatively, machine-readable storage medium 620 may be a portable, external or remote storage medium, for example, that allows system 600 to download the instructions from the portable/external/remote storage medium.

Referring to FIG. 6, database execution instructions 622, when executed by a processor (e.g., 610), may cause system 600 to execute a database (e.g., database 106) in a virtual machine, e.g. virtual machine 102. Database backup request instructions 624, when executed by processor 610 may cause system 600, e.g. virtual machine 102, to receive a database backup request from a computing device external to the virtual machine, e.g. computing device 104 or virtual server appliance 202.

Database backup creation instructions 626, when executed, may cause processor 610 to create a backup image of the database responsive to receiving the database backup request, and database backup image storage instructions 628, when executed, may cause processor 610 to store the database backup image on storage coupled with a virtual storage appliance.

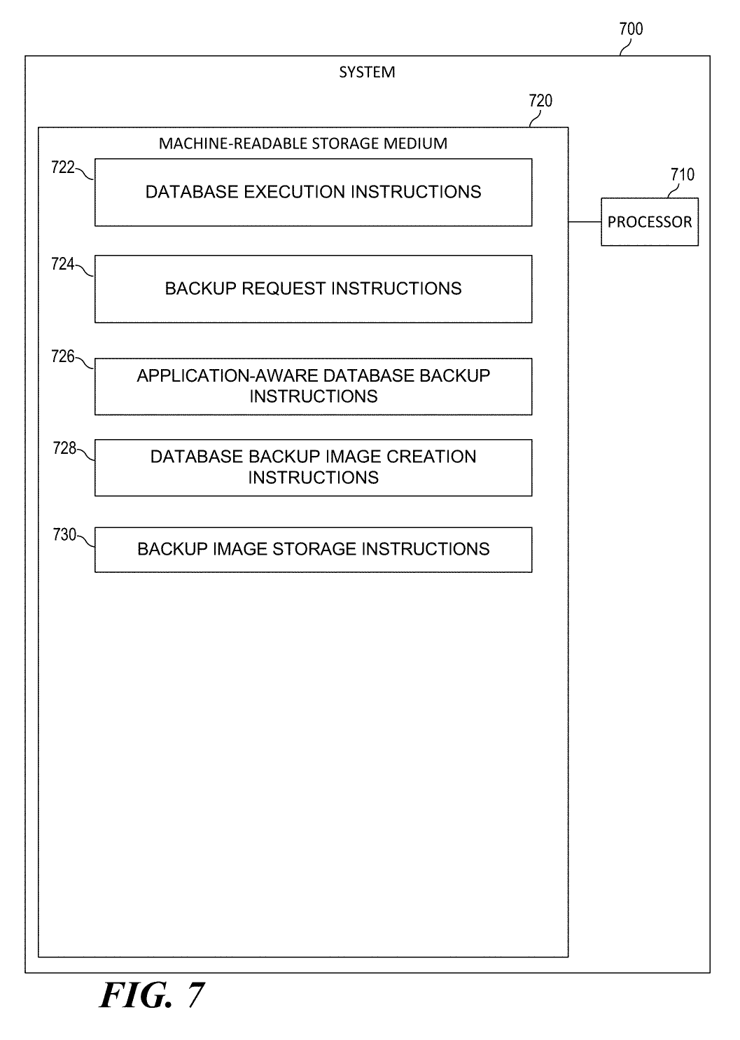

FIG. 7 is a block diagram of an example system for managing firmware of a computing system. In the example of FIG. 7, system 700 includes a processor 710 and a machine-readable storage medium 720. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 710 may be one or more central processing units (CPUs), microprocessors, and/or other hardware devices suitable for retrieval and execution of instructions stored in machine-readable storage medium 720. In the particular example shown in FIG. 7, processor 710 may fetch, decode, and execute instructions 722, 724, 726, 728, 730 to perform application-aware backup of computing system 700. As an alternative or in addition to retrieving and executing instructions, processor 710 may include one or more electronic circuits comprising a number of electronic components for performing the functionality of one or more of the instructions in machine-readable storage medium 720. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Machine-readable storage medium 720 may be any electronic, magnetic, optical, or other physical storage device that stores executable instructions. Thus, machine-readable storage medium 720 may be, for example, Random Access Memory (RAM), an Electrically-Erasable Programmable Read-Only Memory (EEPROM), a storage drive, an optical disc, and the like. Machine-readable storage medium 720 may be disposed within system 700, as shown in FIG. 7. In this situation, the executable instructions may be “installed” on the system 700. Alternatively, machine-readable storage medium 720 may be a portable, external or remote storage medium, for example, that allows system 700 to download the instructions from the portable/external/remote storage medium.

Referring to FIG. 7, database execution instructions 722, when executed by a processor (e.g., 710), may cause system 700 to execute a database (e.g., database 106) in a virtual machine, e.g. virtual machine 102. Backup request instructions 724, when executed, may cause processor 710 to receive a database backup request using an application programming interface (API) of virtual machine 102.

Storage medium 720 may further comprise application-aware database backup instructions 726, which, when executed, may cause processor 710 to perform an application-aware backup of database 106 to create the database backup image 110 using a database backup utility, e.g. backup utility 108. In various examples, the particular database backup utility 108 that is executed may be based on a process that is associated with the database application.

Storage medium 720 may further comprise database backup image creation instructions 728, which when executed, may cause processor 710 to create a database backup image 110 of the database responsive to receiving the database backup request. In some examples, storage medium 720 may comprise backup image storage instructions 730, which may cause processor 710 to store database backup image 110 to disk 214 of virtual machine 102.

1. A method for backing up a database, the method comprising:
executing a database in a virtual machine;
receiving a database backup request from a computing device external to the virtual machine;
performing an application-aware backup of the database using a backup utility executing on the virtual machine to create a database backup image; and
storing the database backup image on storage external to the virtual machine.

2. The method of claim 1, wherein the storage external to the virtual machine comprises a network file system (NFS) share of the virtual server appliance.

3. The method of claim 1, further comprising:
creating at least one of a snapshot image or a read-only disk of the virtual machine; and
hot-adding at least one of the snapshot image or the read-only disk of the virtual machine to the computing device external to the virtual machine.

4. The method of claim 1, further comprising:
creating a snapshot of the virtual machine on the storage; and
replicating the storage containing the virtual machine snapshot.

5. The method of claim 1, further comprising:
executing a backup agent on the computing device external to the virtual machine;
determining processes executing on the virtual machine using an application programming interface (API) of the virtual machine; and
determining a process associated with the database based on the executing processes.

6. The method of claim 5, further comprising:
executing an application-aware database backup utility on the virtual machine using the API of a virtual infrastructure and based on the determined process associated with the database.

7. A computing system comprising:
a virtual machine; and
a computing device external to the virtual machine,
the virtual machine to:
execute a database;
receive a database backup request from the computing device; and
responsive to receiving the database backup request, perform an application-aware backup of the database using a database backup utility to create a database backup image; and
store the database backup image on storage accessible to the computing device.

8. The system of claim 7, wherein the computing device external to the virtual machine to:
use a virtual infrastructure to create a snapshot image of the virtual machine, the snapshot image comprising a backup of the database.

9. The system of claim 8, the computing device further to:
create the snapshot image on storage coupled with virtual machine; and
make the snapshot image accessible to the computing device.

10. The system of claim 8, the computing device further to:
hot-add the snapshot image to the computing device external to the virtual machine.

11. The system of claim 7, the computing device further to:
execute a backup agent on the computing device external to the virtual machine;
determine processes executing on the virtual machine using an application programming interface (API) of the virtual machine; and
determine a process associated with the database.

12. The system of claim 11, the computing device further to:
cause the virtual machine to execute an application-aware database backup application to create the database backup image using an application programming interface of the virtual infrastructure,
wherein the database backup utility that is executed by the virtual machine is based on the determined process associated with the database.

13. A non-transitory machine-readable storage medium encoded with instructions, the instructions that, when executed, cause a processor to:
execute a database in a virtual machine;
receive a database backup request using an application programming interface (API) of the virtual machine;
perform an application-aware backup of the database using a backup utility to create a database backup image; and
store the database backup image on storage coupled with a virtual storage appliance.

14. The non-transitory machine-readable storage medium of claim 13, further comprising instructions that, when executed, cause the processor to store the database backup image on a disk of the virtual machine.

15. The non-transitory machine-readable storage medium of claim 13, wherein the database backup utility that is executed by the virtual machine is based on a process that is associated with the database application.
